(19) United States
(12) Patent Application Publication
(10) Pub. No.: US 2024/0268246 A1
(43) Pub. Date: Aug. 15, 2024

(54) SYSTEMS AND METHODS FOR AUTONOMOUS CROP THINNING

(71) Applicant: Carbon Autonomous Robotic Systems Inc., Seattle, WA (US)

(72) Inventors: Brian Phillip STARK, Bothell, WA (US); Bryson Carlos COREY, Seattle, WA (US); Simon COCHRANE, Seattle, WA (US); Alexander Igorevich SERGEEV, Newcastle, WA (US)

(21) Appl. No.: 18/438,188

(22) Filed: Feb. 9, 2024

Related U.S. Application Data
(60) Provisional application No. 63/444,862, filed on Feb. 10, 2023.

(51) Int. Cl. A01B 41/06; A01M 21/04

(52) U.S. Cl. CPC A01B 41/06; A01M 21/04

(57) ABSTRACT

Systems and methods for autonomously thinning crops in agricultural fields. An autonomous plant targeting system identifies individual crops within the region, evaluates parameters such as spacing, health, and size, and selects specific crops for thinning based on these parameters. The system is capable of designating crop boundaries around individual crops and selecting target crops for removal or eradication, such as by laser irradiation, without affecting surrounding plants.

### CROSS-REFERENCE TO RELATED APPLICATIONS

This application claims priority to U.S. Provisional Application No. 63/444,862, filed Feb. 10, 2023, the contents of which are incorporated herein in its entirety.

All publications, patents, and patent applications mentioned in this specification are herein incorporated by reference to the same extent as if each individual publication, patent, or patent application was specifically and individually indicated to be incorporated by reference.

### FIELD OF THE DISCLOSURE

The present disclosure relates to systems and methods for autonomous crop removal.

### BACKGROUND

As technology advances, tasks that had previously been performed by humans are increasingly becoming automated. While tasks performed in highly controlled environments, such as factory assembly lines, can be automated by directing a machine to perform the task the same way each time, tasks performed in unpredictable environments, such as agricultural environments, depend on dynamic feedback and adaptation to perform the task. Autonomous systems often struggle to identify and locate objects in unpredictable environments. Improved methods of object tracking would advance automation technology and increase the ability of autonomous systems to react and adapt to unpredictable environments.

### SUMMARY OF THE DISCLOSURE

In various aspects, the present disclosure provides a method for autonomous crop thinning, comprising: receiving, by a processor, one or more images of a crop field containing crops; processing, by the processor, the images using a machine learning model to identify one or more individual crops; determining, by the processor, a location and a parameter of each of the one or more identified crops; generating a crop boundary around each identified crop based on the location, the parameter, or both of each of the one or more identified crops; and selecting target crops for removal based on their respective parameters, locations relative to the crop boundaries, or both.

In some aspects, the method further comprises directing an autonomous vehicle equipped with a targeting system capable of removing the selected target crops. In some aspects, the targeting system comprises a laser capable of irradiating the selected target crops. In some aspects, the method further comprises removing the selected target crops with the targeting system. In some aspects, removing the selected target crops comprises irradiating the target crops with a laser. In some aspects, the method further comprises updating the crop boundaries based on real-time feedback from the targeting system. In some aspects, selection of target crops for removal is based at least on a predetermined crop spacing within the crop field. In some aspects, the machine learning model is a convolutional neural network trained to recognize crop features. In some aspects, the parameter of each identified crop includes at least one of health, size, or growth stage. In some aspects, the crop boundary is designated as a geometric shape selected from the group consisting of a rectangle, an ellipse, and a polygon that closely matches a contour of the crop. In some aspects, determining the location of the individual crop may comprise generating a virtual representation of a region around the individual crop.

In various aspects, the present disclosure provides an autonomous plant targeting system comprising: a processor; and a memory comprising instructions stored thereon, which, when executed by the processor causes the system to perform operations comprising: receiving, by the processor, one or more images of a crop field containing crops; processing, by the processor, the images using a machine learning model to identify one or more individual crops; determining, by the processor, a location and a parameter of each of the one or more identified crops; generating, by the processor, a crop boundary around each identified crop based on the location, the parameter, or both of each of the one or more identified crops; and selecting, by the processor, target crops for removal based on their respective parameters, locations relative to the crop boundaries, or both.

In some aspects, the machine learning model is a convolutional neural network trained to recognize crop features. In some aspects, the targeting system comprises a laser capable of irradiating the selected target crops. In some aspects, the system further comprises directing, by the processor, an autonomous vehicle equipped with a targeting system to remove the selected target crops. In some aspects, the autonomous vehicle includes a detection system that dynamically updates a virtual representation of the crop field as the vehicle moves through the field. In some aspects, the autonomous vehicle collects environmental data from the crop field and adjusts the removal operations based on the collected data. In some aspects, the selecting of target crops for removal is further based on a predetermined crop spacing within the crop field. In some aspects, the parameter of each identified crop includes at least one of health, size, or growth stage. In some aspects, the crop boundary is designated as a geometric shape selected from the group consisting of a rectangle, an ellipse, and a polygon that closely matches a contour of the crop. In some aspects, determining the location of the individual crop may comprise generating a virtual representation of a region around the individual crop.

In various aspects, the present disclosure provides a non-transitory computer readable medium containing computer executable instructions that, when executed by a computer hardware arrangement, cause the computer hardware arrangement to perform procedures comprising: receiving one or more images of a crop field containing crops; processing the images using a machine learning model to identify one or more individual crops; determining a location and a parameter of each of the one or more identified crops; generating a crop boundary around each identified crop based on the location, the parameter, or both of each of the one or more identified crops; and selecting target crops for removal based on their respective parameters, locations relative to the crop boundaries, or both.

In some aspects, the techniques described herein relate to a method for autonomous crop thinning, including: receiving, by a processor, one or more images of a crop field containing crops; processing, by the processor, the images using a machine learning model to identify one or more individual crops; determining, by the processor, a location and a parameter of each of the one or more identified crops; generating a crop boundary around each identified crop based on the determined location and the parameter of each of the one or more identified crops; and selecting target crops for removal based on their respective locations and parameters relative to the crop boundaries.

In some aspects, the techniques described herein relate to an autonomous plant targeting system including: a processor; and a memory including instructions stored thereon, which, when executed by the processor causes the system to perform operations including: receiving, by the processor, one or more images of a crop field containing crops; processing, by the processor, the images using a machine learning model to identify one or more individual crops; determining, by the processor, a location and a parameter of each of the one or more identified crops; generating, by the processor, a crop boundary around each identified crop based on the determined location and the parameter of each of the one or more identified crops; and selecting, by the processor, target crops for removal based on their respective locations and parameters relative to the crop boundaries.

In some aspects, the techniques described herein relate to a non-transitory computer readable medium containing computer executable instructions that, when executed by a computer hardware arrangement, cause the computer hardware arrangement to perform procedures including: receiving one or more images of a crop field containing crops; processing the images using a machine learning model to identify one or more individual crops; determining a location and a parameter of each of the one or more identified crops; generating a crop boundary around each identified crop based on the determined location and the parameter of each of the one or more identified crops; and selecting target crops for removal based on their respective locations and parameters relative to the crop boundaries.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an isometric view of an autonomous vehicle for plant removal or eradication, in accordance with one or more embodiments herein.

FIG. 2 illustrates a top view of an autonomous laser plant targeting vehicle navigating a field of crops while implementing various techniques described herein.

FIG. 3 illustrates a side view of a detection system positioned on an autonomous system for plant removal or eradication, in accordance with one or more embodiments herein.

FIG. 4 is a block diagram depicting components of a prediction system and a targeting system for identifying, locating, targeting, and manipulating an object, in accordance with one or more embodiments herein.

FIG. 5 is a block diagram illustrating components of a detection terminal in accordance with embodiments of the present disclosure.

FIG. 6 is an exemplary block diagram of a computing device architecture of a computing device which can implement the various techniques described herein.

FIG. 7A illustrates a bounding region-based plant detection method.

FIG. 7B illustrates a mask-based plant detection method.

FIG. 8A illustrates a virtual representation of a field containing crops identified and selected for targeting.

FIG. 8B illustrates a virtual representation of a field containing crops identified and selected for targeting, in accordance with one or more embodiments herein.

FIG. 9A is a flow diagram illustrating a method of autonomously thinning crops, according to example embodiments of the present disclosure.

FIG. 9B is a flow diagram illustrating a method of autonomously removing, according to example embodiments of the present disclosure.

### DETAILED DESCRIPTION

Described herein are systems and methods for autonomously thinning and maintaining crops. Crop thinning may comprise targeting and removing or eradicating select crops to maintain crop density at a desired level. Reducing crop density may improve growth or survivability of the remaining crops. Crop thinning may be used to counterbalance practices of over planting, which may be done to compensate for the proportion of planted seeds that fail to germinate. An autonomous crop thinning method of the present disclosure may comprise identifying and targeting select crops based on parameters including plant spacing, plant health, plant size, growth stage, or combinations thereof. As described herein, an autonomous plant targeting system may identify and locate crops in a region, evaluate parameters of the crops (e.g., spacing, health, size, or combinations thereof), select crops for thinning based on one or more of the parameters, and remove or eradicate the selected crops (e.g., by irradiating the crop with a laser). In some embodiments, removal or eradication may comprise killing, heating, burning, irradiating, cutting, moving, or spraying the crop. Examples of crops that may be thinned using the methods described herein include onion, pepper, strawberry, carrot, corn, soybeans, barley, oats, wheat, alfalfa, cotton, hay, tobacco, rice, sorghum, tomato, potato, grape, rice, lettuce, bean, pea, sugar beet, or brassica (e.g., broccoli, cauliflower, mustard, kale, or brussels sprouts). In some embodiments, thinning may be performed concurrently with weeding. For example, an autonomous plant targeting system may perform both crop thinning and weeding as it moves through a crop field.

The technology described in the patent document for autonomous crop thinning represents a substantial advancement over previous agricultural automation technologies. Traditional methods of crop thinning have largely been manual, requiring substantial human labor which can be both time-consuming and costly. The systems and methods described in this patent document address these limitations by introducing a high degree of autonomy and precision in identifying, selecting, and targeting individual crops for thinning. Unlike earlier technologies, this autonomous crop thinning system utilizes advanced imaging and predictive analytics to create a virtual representation of the crop field. This allows for dynamic feedback and real-time adaptation to the specific conditions of the field. The system's ability to designate crop boundaries and select target crops based on a combination of location, health, and size parameters is a marked improvement over less sophisticated systems that may not account for such a comprehensive range of factors. Furthermore, the use of laser irradiation for targeting selected crops offers a level of precision that minimizes damage to surrounding crops, which is a common drawback of bulkier mechanical thinning equipment.

The technology provides a solution to several technological problems associated with automated crop thinning in unpredictable agricultural environments. One of the primary challenges in automating agricultural tasks is the variability and unpredictability of natural growth patterns and environmental conditions. The autonomous crop thinning system addresses this by incorporating advanced object tracking and identification methods that can adapt to the dynamic nature of crop fields. By generating a virtual representation of the region and continuously updating it as the autonomous system moves through the field, the technology ensures that decisions about which crops to thin are based on the latest data, thereby optimizing crop density and health. Another technological problem that this system solves is the difficulty in selectively targeting individual crops without affecting the surrounding plants. The precision targeting enabled by laser technology ensures that the system can remove or eradicate unwanted crops without collateral damage. This level of precision is a technological solution that manual or mechanical methods cannot easily replicate. Additionally, the system's ability to dynamically update the average crop size and make thinning decisions based on real-time deviations from this average represents a sophisticated approach to maintaining crop uniformity and optimizing field yield. In summary, the autonomous crop thinning technology described in this patent document offers a comprehensive and precise solution to the challenges of automating crop management tasks in variable and unpredictable environments. Its integration of advanced imaging, predictive analytics, and precise targeting methods represents a notable improvement over past technologies and provides a clear technological solution to the problems faced in modern agriculture.

Described herein are systems and methods for autonomously thinning and maintaining crops. Crop thinning may comprise targeting and removing or eradicating select crops to maintain crop density at a desired level. Reducing crop density may improve growth or survivability of the remaining crops. Crop thinning may be used to counterbalance practices of over planting, which may be done to compensate for the proportion of planted seeds that fail to germinate. An autonomous crop thinning method of the present disclosure may comprise identifying and targeting select crops based on parameters including plant spacing, plant health, plant size, growth stage, or combinations thereof. As described herein, an autonomous plant targeting system may identify and locate crops in a region, evaluate parameters of the crops (e.g., spacing, health, size, or combinations thereof), select crops for thinning based on one or more of the parameters, and remove or eradicate the selected crops (e.g., by irradiating the crop with a laser). Examples of crops that may be thinned using the methods described herein include onion, pepper, strawberry, carrot, corn, soybeans, barley, oats, wheat, alfalfa, cotton, hay, tobacco, rice, sorghum, tomato, potato, grape, rice, lettuce, bean, pea, sugar beet, or brassica (e.g., broccoli, cauliflower, mustard, kale, or brussels sprouts). In some embodiments, thinning may be performed concurrently with weeding. For example, an autonomous plant targeting system may perform both crop thinning and weeding as it moves through a crop field.

As used herein, an “image” may refer to a representation of a region or object. For example, an image may be a visual representation of a region or object formed by electromagnetic radiation (e.g., light, x-rays, microwaves, or radio waves) scattered off of the region or object. In another example, an image may be a point cloud model formed by a light detection and ranging (LIDAR) or a radio detection and ranging (RADAR) sensor. In another example, an image may be a sonogram produced by detecting sonic, infrasonic, or ultrasonic waves reflected off of the region or object. As used herein, “imaging” may be used to describe a process of collecting or producing a representation (e.g., an image) of a region or an object.

As used herein a position, such as a position of an object or a position of a sensor, may be expressed relative to a frame of reference. Exemplary frames of reference include a surface frame of reference, a vehicle frame of reference, a sensor frame of reference, or an actuator frame of reference. Positions may be readily converted between frames of reference, for example by using a conversion factor or a calibration model. While a position, a change in position, or an offset may be expressed in a one frame of reference, it should be understood that the position, change in position, or offset may be expressed in any frame of reference or may be readily converted between frames of reference.

As used herein, a “sensor” may refer to a device capable of detecting or measuring an event, a change in an environment, or a physical property. For example, a sensor may detect light, such as visible, ultraviolet, or infrared light, and generate an image. Examples of sensors include cameras (e.g., a charge-coupled device (CCD) camera or a complementary metal-oxide-semiconductor (CMOS) camera), a LIDAR detector, an infrared sensor, an ultraviolet sensor, or an x-ray detector.

As used herein, “object” may refer to an item or a distinguishable area that may be observed, tracked, manipulated, or targeted. For example, an object may be a plant, such as a crop or a weed. In another example, an object may be a piece of debris. In another example, an object may be a distinguishable region or point on a surface, such as a marking or surface irregularity.

As used herein, “targeting” or “aiming” may refer to pointing or directing a device or action toward a particular location or object. For example, targeting an object may comprise pointing a sensor (e.g., a camera) or implement (e.g., a laser) toward the object. Targeting or aiming may be dynamic, such that the device or action follows an object moving relative to the targeting system. For example, a device positioned on a moving vehicle may dynamically target or aim at an object located on the ground by following the object as the vehicle moves relative to the ground.

As used herein, a “weed” may refer to an unwanted plant, such as a plant of an unwanted type or a plant growing in an undesirable place or at an undesirable time. For example, a weed may be a wild or invasive plant. In another example, a weed may be a plant within a field of cultivated crops that is not the cultivated species. In another example, a weed may be a plant growing outside of or between cultivated rows of crops. As used herein, a “crop” may be a cultivated plant.

As used herein, “manipulating” an object may refer to performing an action on, interacting with, or altering the state of an object. For example, manipulating may comprise irradiating, illuminating, heating, burning, killing, moving, lifting, grabbing, spraying, or otherwise modifying an object.

As used herein, “electromagnetic radiation” may refer to radiation from across the electromagnetic spectrum. Electromagnetic radiation may include, but is not limited to, visible light, infrared light, ultraviolet light, radio waves, gamma rays, or microwaves.

### Autonomous Plant Targeting Systems

The object tracking methods described herein may be implemented by an autonomous plant targeting system to target and eliminate selected plants. Such tracking methods may facilitate object tracking relative to a moving body, such as a moving vehicle. For example, an autonomous plant targeting system may be used to track a plant of interest identified in images or representations collected by a first sensor, such as a prediction sensor, over time relative to the autonomous plant targeting system while the system is in motion relative to the plant. The tracking information may be used to determine a predicted location of the plant relative to the system at a later point in time. The autonomous plant targeting system may then locate the same plant in an image or representation collected by a second sensor, such as a targeting sensor, using the predicted location. In some embodiments, the first sensor is a prediction camera, and the second sensor is a targeting camera. One or both of the first sensor and the second sensor may be moving relative to the plant. For example, the prediction camera may be coupled to and moving with the autonomous plant targeting system.

Targeting the plant may comprise precisely locating the plant using the targeting sensor, targeting the plant with a laser, and removing or eradicating the plant by burning it with laser light, such as infrared light. The prediction sensor may be part of a prediction module configured to determine a predicted location of an object of interest, and the targeting sensor may be part of a targeting module configured to refine the predicted location of the object of interest to determine a target location and target the object of interest with the laser at the target location. The prediction module may be configured to communicate with the targeting module to coordinate a camera handoff using point to point targeting, as described herein. The targeting module may target the object at the predicted location. In some embodiments, the targeting module may use the trajectory of the object to dynamically target the object while the system is in motion such that the position of the targeting sensor, the laser, or both is adjusted to maintain the target.

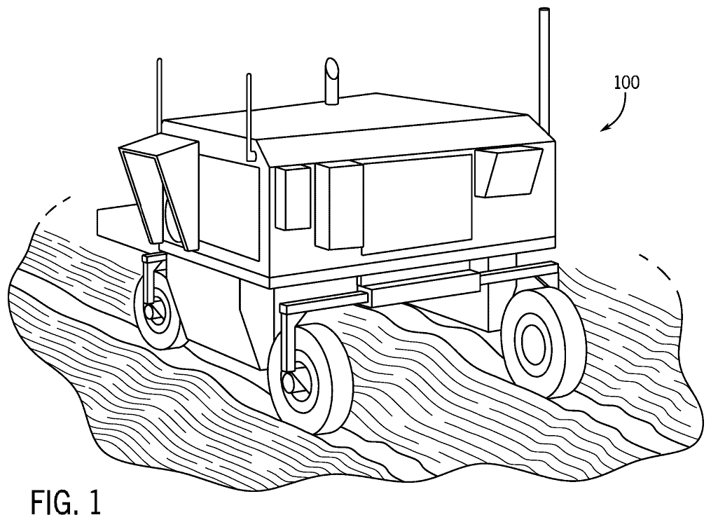

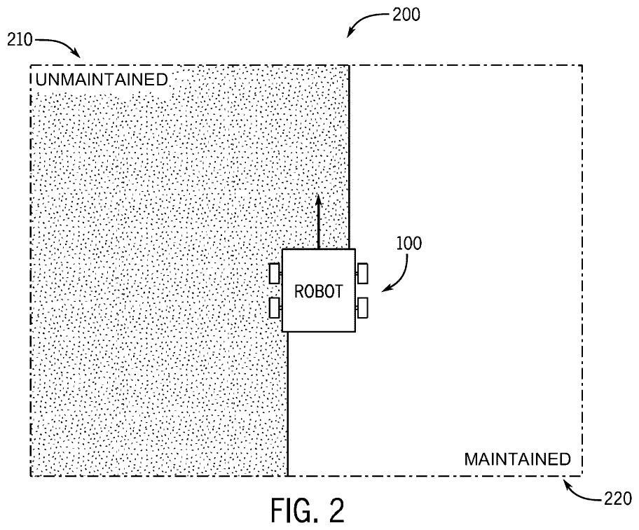

An autonomous plant targeting system may identify, target, and eliminate plants without human input. Optionally, the autonomous plant targeting system may be positioned on a self-driving vehicle or a piloted vehicle or may be a trailer pulled by another vehicle such as a tractor. As illustrated in FIG. 1, an autonomous plant targeting system may be part of or coupled to a vehicle 100, such as a tractor or self-driving vehicle. The vehicle 100 may drive through a field of crops 200, as illustrated in FIG. 2. As the vehicle 100 drives through the crop field 200 it may identify, target, and remove or eradicate plants in an unmaintained section 210 of the field, leaving a maintained field 220 behind it. The object tracking methods described herein may be implemented by the autonomous plant targeting system to identify, target, and remove or eradicate plants while the vehicle 100 is in motion. The high precision of such tracking methods enables accurate targeting of plants, such as with a laser, to remove or eradicate the plants without damaging nearby crops. U.S. Pat. No. 11,602,143, which is incorporated by reference, describes autonomous targeting systems that may be used to perform a method of the present disclosure.

While the primary focus of the patent application is on the identification, selection, and targeting of plants for the purpose of autonomous crop thinning, the underlying technology is not limited to plant detection. The system's advanced imaging and predictive analytics capabilities are designed to identify and locate objects in unpredictable environments, which inherently allows for the detection of a wide range of objects beyond just plants. The methods and systems described are capable of distinguishing and tracking any distinguishable items or areas that can be observed within their operational field. This includes, but is not limited to, debris, infrastructure elements, or other items that may be present in an agricultural setting. The flexibility and adaptability of the system's object tracking technology enable it to be applied to various scenarios where autonomous detection and manipulation of objects are beneficial. Therefore, while the application predominantly illustrates the system's utility in an agricultural context, the principles and mechanisms of object detection and targeting it employs can be generalized to other applications for which identifying and interacting with various objects is requisite.

In some embodiments, the object tracking methods described herein may be performed by a detection system. The detection system may comprise a prediction system and, optionally, a targeting system. In some embodiments, the detection system may be positioned on or coupled to a vehicle, such as a self-driving plant targeting vehicle or a plant targeting trailer pulled by a tractor. The prediction system may comprise a prediction sensor configured to image a region of interest, and the targeting system may comprise a targeting sensor configured to image a portion of the region of interest. Imaging may comprise collecting a representation (e.g., an image) of the region of interest or the portion of the region of interest. In some embodiments, the prediction system may comprise two or more prediction sensors, enabling coverage of a larger region of interest. In some embodiments, the targeting system may comprise two or more targeting sensors.

The region of interest may correspond to a region of overlap between the targeting sensor field of view and the prediction sensor field of view. Such overlap may be contemporaneous or may be temporally separated. For example, the prediction sensor field of view encompasses the region of interest at a first time and the targeting sensor field of view encompasses the region of interest at a second time but not at the first time. Optionally, the detection system may move relative to the region of interest between the first time and the second time, facilitating temporally separated overlap of the prediction sensor field of view and the targeting sensor field of view.

In some embodiments the prediction sensor may have a wider field of view than the targeting sensor. The prediction system may further comprise an object identification module to identify an object of interest in a prediction image or representation collected by the prediction sensor. The object identification module may differentiate an object of interest from other objects in the prediction image.

The prediction module may determine a predicted location of the object of interest and may send the predicted location to the targeting system. The predicted location of the object may be determined using the object tracking methods described herein.

The targeting system may point the targeting sensor toward a desired portion of the region of interest predicted to contain the object, based on the predicted location received from the prediction system. In some embodiments, the targeting module may direct an implement toward the object. In some embodiments, the implement may perform an action on or manipulate the object. In some embodiments, the targeting module may use the trajectory of the object to dynamically target the object while the system is in motion such that the position of the targeting sensor, the implement, or both is adjusted to maintain the target. U.S. patent application Ser. No. 17/576,814, which is incorporated by reference, describes machine learning models for automated identification, maintenance, control, or targeting of objects.

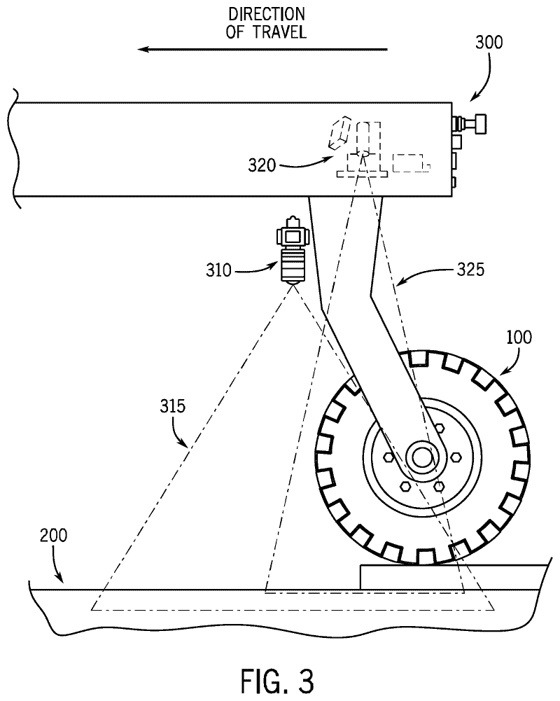

An example of a detection system 300 is provided in FIG. 3. The detection system may be part of or coupled to a vehicle 100, such as a self-driving plant targeting vehicle or a laser plant targeting system trailer pulled by a tractor, that moves along a surface, such as a crop field 200. The detection system 300 includes a prediction module 310, including a prediction sensor with a prediction field of view 315, and a targeting module 320, including a targeting sensor with a targeting field of view 325. The targeting module may further include an implement, such as a laser, with a target area that overlaps with the targeting field of view 325. In some embodiments, the prediction module 310 is positioned ahead of the targeting module 320, along the direction of travel of the vehicle 100, such that the targeting field of view 325 overlaps with the prediction field of view 315 with a temporal delay. For example, the prediction field of view 315 at a first time may overlap with the targeting field of view 325 at a second time. In some embodiments, the prediction field of view 315 at the first time may not overlap with the targeting field of view 325 at the first time.

The prediction module is primarily responsible for the initial identification and tracking of objects. It utilizes a prediction sensor, which could be a camera or another type of imaging device, to capture images or representations of a region of interest. This module processes the collected data to generate a virtual representation of the region, identifying the locations and parameters of individual objects, such as crops, within that space.

Once an object has been identified and its trajectory predicted, the prediction module communicates this information to the targeting module. The targeting module is equipped with a targeting sensor that receives the predicted location of the object from the prediction module. Using this data, the targeting module can then precisely aim an implement, such as a laser, at the object. The targeting sensor ensures that the implement is accurately directed towards the object's current or future location, accounting for any movement of the object or the autonomous system itself. The prediction module's ability to forecast the object's location allows the targeting module to compensate for any delays between the identification of the object and the moment of action, ensuring that the targeting is precise and effective. This coordination is particularly useful when the autonomous system is in motion, as it allows for dynamic adjustments to be made in real-time, ensuring that the targeting remains accurate despite any changes in the relative positions of the system and the objects.

In other example embodiments, the system does not require the prediction system to be physically located in front of the targeting system. The primary objective is to ensure that the prediction system's field of view precedes the targeting system's field of view in the direction of the system's movement, allowing for the timely prediction and subsequent targeting of objects. As a nonlimiting example, in other example embodiments the prediction sensor may be angled in such a way that its field of view extends further ahead in the travel path, even if the sensor itself is not positioned at the frontmost point of the system. This flexibility in sensor arrangement is particularly advantageous in scenarios where space constraints or design considerations necessitate a more compact or non-linear configuration of system components.

A detection system of the present disclosure may be used to target objects on a surface, such as the ground, a dirt surface, a floor, a wall, an agricultural surface (e.g., a field), a lawn, a road, a mound, a pile, or a pit. In some embodiments, the surface may be a non-planar surface, such as uneven ground, uneven terrain, or a textured floor. For example, the surface may be uneven ground at a construction site, in an agricultural field, or in a mining tunnel, or the surface may be uneven terrain containing fields, roads, forests, hills, mountains, houses, or buildings. The detection systems described herein may locate an object on a non-planar surface more accurately, faster, or within a larger area than a single sensor system or a system lacking an object matching module.

Alternatively or in addition, a detection system may be used to target objects that may be spaced from the surface they are resting on, such as a tree top distanced from its grounding point, and/or to target objects that may be locatable relative to a surface, for example, relative to a ground surface in air or in the atmosphere. In addition, a detection system may be used to target objects that may be moving relative to a surface, for example, a vehicle, an animal, a human, or a flying object.

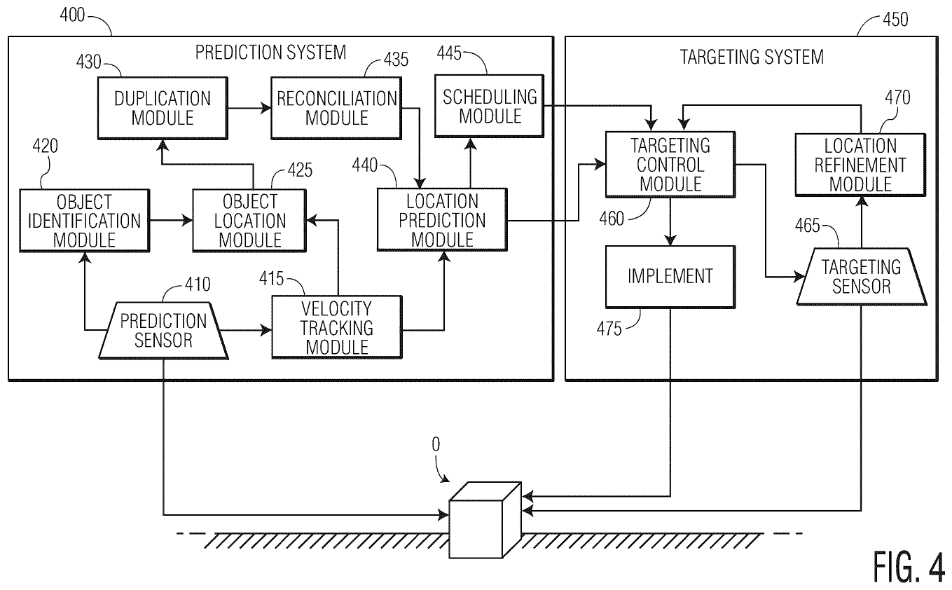

FIG. 4 illustrates a detection system comprising a prediction system 400 and a targeting system 450 for tracking at targeting an object O relative to a moving body, such as vehicle 100 illustrated in FIG. 1-FIG. 3. The prediction system 400, the targeting system 450, or both may be positioned on or coupled to the moving body (e.g., the moving vehicle). The prediction system 400 may comprise a prediction sensor 410 configured to image a region, such as a region of a surface, containing one or more objects, including object O. Optionally, the prediction system 400 may include a velocity tracking module 415. The velocity tracking module may estimate a velocity of the moving body relative to the region (e.g., the surface). In some embodiments, the velocity tracking module 415 may comprise a device to measure the displacement of the moving body over time, such as a rotary encoder. Alternatively or in addition, the velocity tracking module may use images collected by the prediction system 400 to estimate the velocity using optical flow.

The object identification module 420 may identify objects in images collected by the prediction sensor. For example, the object identification module 420 may identify plants in an image and may differentiate the plants from other plants in the image, such as crops. The object location module 425 may determine locations of the objects identified by the object identification module 420 and to compile a set of identified objects and their corresponding locations. Object identification and object location may be performed on a series of images collected by the prediction sensor 410 over time. The set of identified objects and corresponding locations from in two or more images from the object location module 425 may be sent to the deduplication module 430.

In some embodiments, the object identification module 420 may employ machine learning models, which are trained to identify specific features of objects based on a large dataset of labeled images. The training process involves feeding the model numerous examples of images that contain the objects of interest, along with annotations that describe what the objects are and where they are located within the images. For example, in the context of crop thinning, the model might learn to recognize the shape, color, texture, and size of various crops and weeds. The model is trained to differentiate between these plants, allowing it to identify which ones are crops that ought to be preserved and which are weeds or excess crops that can be targeted for removal. Once trained, the object identification module 420 can process new images from the prediction sensor and apply the learned patterns to identify objects in real-time. It can differentiate objects of interest from the background and other objects that are not relevant to the task at hand. The module may use various machine learning techniques, such as convolutional neural networks (CNNs).

The deduplication module 430 may use object locations in a first image collected at a first time and object locations in a second image collected at a second time to identify objects, such as object O, appearing in both the first image and the second image. The set of identified objects and corresponding locations may be deduplicated by the deduplication module 430 by assigning locations of an object appearing in both the first image and the second image to the same object O. In some embodiments, the deduplication module 430 may use a velocity estimate from the velocity tracking module 415 to identify corresponding objects appearing in both images. The resulting deduplicated set of identified objects may contain unique objects, each of which has one or more corresponding locations determined at one or more time points.

Machine learning can be applied to this process by using models that recognize and match features of objects across different images. For instance, a machine learning model could be trained on a dataset of sequential images where objects of interest move or change appearance slightly. The model would learn to associate different instances of the same object across these images, despite variations in perspective, lighting, or partial occlusions. Such a model could use techniques like feature matching and object tracking algorithms that are robust to changes in the object's environment. By learning the typical motion patterns or changes in appearance of objects within the field, the deduplication module could more accurately determine when different images feature the same object, thereby reducing the likelihood of counting an object more than once.

The reconciliation module 435 may receive the deduplicated set of objects from the deduplication module 430 and may reconcile the deduplicated set by removing objects. In some embodiments, objects may be removed if they are no longer being tracked. For example, an object may be removed if it has not been identified in a predetermined number of images in the series of images. In another example, an object may be removed if it has not been identified in a predetermined period of time. In some embodiments, objects no longer appearing in images collected by the prediction sensor 410 may continue to be tracked. For example, an object may continue to be tracked if it is expected to be within the prediction field of view based on the predicted location of the object. In another example, an object may continue to be tracked if it is expected to be within range of a targeting system based on the predicted location of the object. The reconciliation module 435 may provide the reconciled set of objects to the location prediction module 440.

The reconciliation module is responsible for maintaining an accurate and current list of objects being tracked. It removes objects that are no longer relevant, such as those that have not been detected for a set period or number of frames. Machine learning can assist in this process by predicting which objects are likely to reappear based on their last known trajectory and the typical behavior of objects within the environment. A predictive machine learning model could analyze the movement patterns of objects and predict their future positions. If an object temporarily disappears from view—perhaps due to occlusion or moving out of the frame—the model could estimate the likelihood of its return. This would allow the reconciliation module to make informed decisions about whether to keep tracking an object or remove it from the list, optimizing the system's resources and attention.

The location prediction module 440 may determine a predicted location at a future time of object O from the reconciled set of objects. In some embodiments, the predicted location may be determined from two or more corresponding locations determined from images collected at two or more time points or from a single location combined with velocity information from the velocity tracking module 415. The predicted location of object O may be based on a vector velocity, including speed and direction, of object O relative to the moving body between the location of object O in a first image collected at a first time and the location of object O in a second image collected at a second time. Optionally, the vector velocity may account for a distance of the object O from the moving body along the imaging axis (e.g., a height or elevation of the object relative to the surface). Alternatively or in addition, the predicted location of the object may be based on the location of object O in the first image or in the second image and a vector velocity of the vehicle determined by the from the velocity tracking module 415.

The targeting system 450 may receive the predicted location of the object O at a future time from the prediction system 400 and may use the predicted location to precisely target the object with an implement 475 at the future time. The targeting control module 460 of the targeting system 450 may receive the predicted location of object O from the location prediction module 440 of the prediction system 400 and may instruct the targeting sensor 465, the implement 475, or both to point toward the predicted location of the object. Optionally, the targeting sensor 465 may collect an image of object O, and the location refinement module 470 may refine the predicted location of object O based on the location of object O determined from the image. In some embodiments, the location refinement module 470 may account for optical distortions in images collected by the prediction sensor 410 or the targeting sensor 465, or for distortions in angular motions of the implement 475 or the targeting sensor 465 due to nonlinearity of the angular motions relative to object O. The targeting control module 460 may instruct the implement 475, and optionally the targeting sensor 465, to point toward the refined location of object O. In some embodiments, the targeting control module 460 may adjust the position of the targeting sensor 465 or the implement 475 to follow the object to account for motion of the vehicle while targeting. The implement 475, such as a laser, may then manipulate object O. For example, a laser may direct infrared light toward the predicted or refined location of object O. Object O may be a plant and directing infrared light toward the location of the plant may remove or eradicate the plant.

In some embodiments, a prediction system 400 may further comprise a scheduling module 445. The scheduling module 445 may select objects identified by prediction module and schedule which ones to target with the targeting system. The scheduling module 445 may schedule objects for targeting based on parameters such as object location, relative velocity, implement activation time, confidence score, or combinations thereof. For example, the scheduling module 445 may prioritize targeting objects predicted to move out of a field of view of a prediction sensor or a targeting sensor or out of range of an implement. Alternatively or in addition, a scheduling module 445 may prioritize targeting objects identified or located with high confidence. Alternatively or in addition, a scheduling module 445 may prioritize targeting objects with short activation times. In some embodiments, a scheduling module 445 may prioritize targeting objects based on a user's preferred parameters.

The targeting system, which includes a targeting control module and a targeting sensor, could be designed to handle multiple targets by scheduling the targeting sequence based on various parameters such as object location, relative velocity, and implement activation time. The scheduling module 445 could prioritize objects and orchestrate the targeting sequence to efficiently transition between multiple targets. For the targeting sensor to engage multiple targets at once, it could utilize a rapid point-to-point movement system to quickly redirect the laser or other implements from one target to the next. Alternatively, if the technology allows, the implement could be a multi-beam laser capable of splitting its focus to target several locations in quick succession or even simultaneously, depending on the spatial arrangement of the targets and the capabilities of the laser system. Advanced algorithms within the targeting control module would generate the precise timing and movement patterns to align the laser with each predicted location of the objects. This would enable the targeting sensor to follow a pre-determined path that intersects with the objects at the right moments, considering the continuous movement of the autonomous plant targeting system through the field.

### Prediction Modules

A prediction module of the present disclosure may be configured to track objects relative to a moving body using the tracking methods described herein. In some embodiments, a prediction module is configured to capture an image or representation of a region of a surface using the prediction camera or prediction sensor, identify an object of interest in the image, and determine a predicted location of the object.

The prediction module may include an object identification module configured to identify an object of interest and differentiate the object of interest from other objects in the prediction image. In some embodiments, the prediction module uses a machine learning model to identify and differentiate objects based on features extracted from a training dataset comprising labeled images of objects. For example, the machine learning model of or associated with the object identification module may be trained to identify plants and differentiate plants of interest from other plants, such as crops. In another example, the machine learning model of or associated with the object identification module may be trained to identify debris and differentiate debris from other objects. The object identification module may be configured to identify a plant and to differentiate between different plants, such as between a crop and a weed. In some embodiments, the machine learning model may be a deep learning model, such as a deep learning neural network.

In some embodiments, the object identification module comprises using an identification machine learning model, such as a convolutional neural network. The identification machine learning model may be trained with many images, such as high-resolution images, for example of surfaces with or without objects of interest. For example, the machine learning model may be trained with images of fields with or without weeds. Once trained, the machine learning model may be configured to identify a region in the image containing an object of interest. The region may be defined by a polygon, for example a rectangle. In some embodiments, the region is a bounding box. In some embodiments, the region is a polygon mask covering an identified region. In some embodiments, the identification machine learning model may be trained to determine a location of the object of interest, for example a pixel location within a prediction image.

The prediction module may further comprise a velocity tracking module to determine the velocity of a vehicle to which the prediction module is coupled. In some embodiments, the positioning system and the detection system may be positioned on the vehicle. Alternatively or in addition, the positioning system may be positioned on a vehicle that is spatially coupled to the detection system. For example, the positioning system may be located on a vehicle pulling the detection system. The velocity tracking module may comprise a positioning system, for example a wheel encoder or rotary encoder, an Inertial Measurement Unit (IMU), a Global Positioning System (GPS), a ranging sensor (e.g., laser, SONAR, or RADAR), or an Internal Navigation System (INS). For example, a wheel encoder in communication with a wheel of the vehicle may estimate a velocity or a distance traveled based on angular frequency, rotational frequency, rotation angle, or number of wheel rotations. In some embodiments, the velocity tracking module may utilize images from the prediction sensor to determine the velocity of the vehicle using optical flow.

The prediction module may comprise a system controller, for example a system computer having storage, random access memory (RAM), a central processing unit (CPU), and a graphics processing unit (GPU). The system computer may comprise a tensor processing unit (TPU). The system computer may comprise sufficient RAM, storage space, CPU power, and GPU power to perform operations to detect and identify a target. The prediction sensor may provide images of sufficient resolution on which to perform operations to detect and identify an object. In some embodiments, the prediction sensor may be a camera, such as a charge-coupled device (CCD) camera or a complementary metal-oxide-semiconductor (CMOS) camera, a LIDAR detector, an infrared sensor, an ultraviolet sensor, an x-ray detector, or any other sensor capable of generating an image.

### Targeting Modules

A targeting module of the present disclosure may be configured to target an object tracked by a prediction module. In some embodiments, the targeting module may direct an implement toward the object to manipulate the object. For example, the targeting module may be configured to direct a laser beam toward a plant to burn the plant. In another example, the targeting module may be configured to direct a grabbing tool to grab the object. In another example, the targeting module may direct a spraying tool to spray fluid at the object. In some embodiments, the object may be a weed, a plant, an insect, a pest, a field, a piece of debris, an obstruction, a region of a surface, or any other object that may be manipulated. The targeting module may be configured to receive a predicted location of an object of interest from the prediction module and point the targeting camera or targeting sensor toward the predicted location. In some embodiments, the targeting module may direct an implement, such as a laser, toward the predicted location. The position of the targeting sensor and the position of the implement may be coupled. In some embodiments, two or more targeting modules are in communication with the prediction module.

The targeting module may comprise a targeting control module. In some embodiments, the targeting control module may control the targeting sensor, the implement, or both. In some embodiments, the targeting control module may comprise an optical control system comprising optical components configured to control an optical path (e.g., a laser beam path or a camera imaging path). The targeting control module may comprise software-driven electrical components capable of controlling activation and deactivation of the implement. Activation or deactivation may depend on the presence or absence of an object as detected by the targeting camera. Activation or deactivation may depend on the position of the implement relative to the target object location. In some embodiments, the targeting control module may activate the implement, such as a laser emitter, when an object is identified and located by the prediction system. In some embodiments, the targeting control module may activate the implement when the range or target area of the implement is positioned to overlap with the target object location.

The targeting control module may deactivate the implement once the object has been manipulated, such as grabbed, sprayed, burned, or irradiated; the region comprising the object has been targeted with the implement; the object is no longer identified by the target prediction module; a designated period of time has elapsed; or any combination thereof. For example, the targeting control module may deactivate the emitter once a region on the surface comprising a plant has been scanned by the beam, once the plant has been irradiated or burned, or once the beam has been activated for a pre-determined period of time.

The prediction modules and the targeting modules described herein may be used in combination to locate, identify, and target an object with an implement. The targeting control module may comprise an optical control system as described herein. The prediction module and the targeting module may be in communication, for example electrical or digital communication. In some embodiments, the prediction module and the targeting module are directly or indirectly coupled. For example, the prediction module and the targeting module may be coupled to a support structure. In some embodiments, the prediction module and the targeting module are configured on or coupled to a vehicle, such as the vehicle shown in FIG. 1 and FIG. 2. For example, the prediction module and the targeting module may be positioned on a self-driving vehicle. In another example, the prediction module and the targeting module may be positioned on a trailer pulled by another vehicle, such as a tractor.

The targeting module may comprise a system controller, for example a system computer having storage, random access memory (RAM), a central processing unit (CPU), and a graphics processing unit (GPU). The system computer may comprise a tensor processing unit (TPU). The system computer may comprise sufficient RAM, storage space, CPU power, and GPU power to perform operations to detect and identify a target. The targeting sensor may provide images of sufficient resolution on which to perform operations to match an object to an object identified in a prediction image.

### Autonomous Crop Thinning

An autonomous crop thinning method of the present disclosure may comprise automated targeting and removal of select crops to reduce crop density to a desired level. Selection of crops for thinning may be based on various plant parameters, such as spacing, health, size, growth stage, or combinations thereof. An autonomous plant targeting system of the present disclosure may be used to identify plants in a region (e.g., a crop field), determine locations of the plants in the region, and determine parameters of the plants.

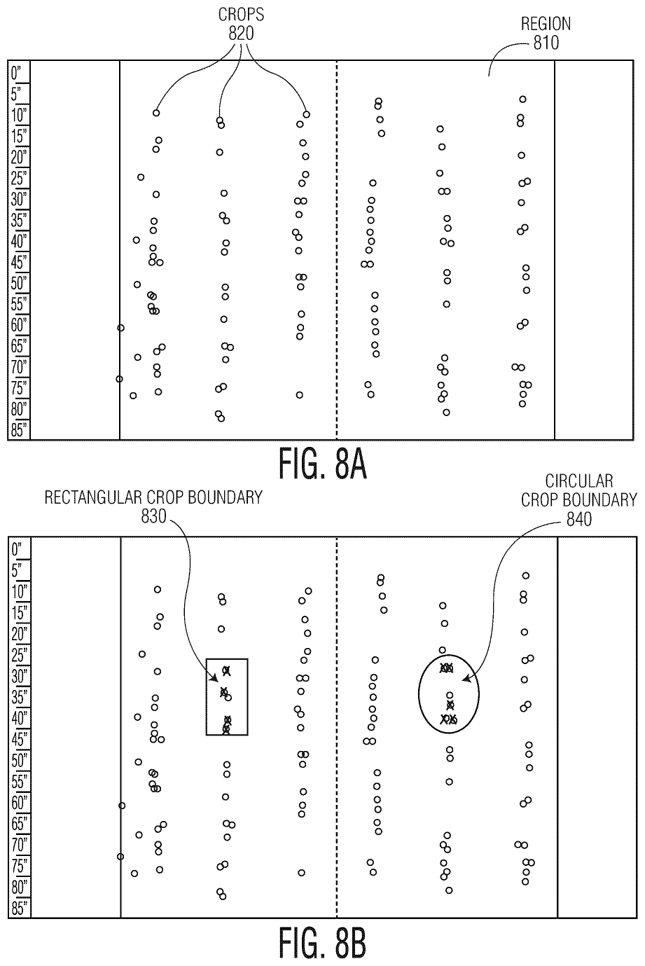

During autonomous crop thinning, plants may be identified and tracked over time to generate a virtual region, as illustrated in FIG. 8A and FIG. 8B, that may be updated in real time as an autonomous plant targeting system moves through a crop field. In some embodiments, a virtual region may be generated based on images from one or more sensors (e.g., a prediction sensor, a targeting sensor, or combinations thereof). The virtual region may represent positions of crops relative to an autonomous plant targeting system. The plants identified in the images may be combined into a virtual region and duplicate plants removed. Crops may be identified and selected for thinning based on the locations of crops in the virtual region, determined parameters of the crop, or both. For example, a crop may be thinned to a desired spacing. The desired spacing may depend on crop type. In another example, a crop may be thinned based on a crop health, such that unhealthy crops are thinned.

An example of a method of autonomous crop thinning is described with respect to FIG. 8A and FIG. 8B. FIG. 8A and FIG. 8B illustrate a virtual representation of a region 810 (e.g., a crop field) with locations of crops 820 marked with blue circles. In FIG. 8A and FIG. 8B, crops tend to fall along rows corresponding to crop seedlines. Crop arrangement and distribution may vary by planting style or arrangement, and the methods described herein are not limited to a particular crop arrangement. As an autonomous plant targeting system moves through a crop field, crops may be identified and added to the virtual representation to be tracked. As a crop is tracked, the autonomous plant targeting system may determine whether the crop should be targeted for thinning. The determination may be made based on crop location, proximity to other crops, crop health, growth stage, or crop size. In some embodiments, the evaluation may be performed by a greedy algorithm, which may comprise tracking a crop until it reaches a certain point in tracking space (e.g., a certain position in the virtual region, a certain position relative to the targeting system, or a certain tracking time duration) and then evaluating whether that crop should be thinned. The evaluation may be based on crop boundary collisions, crop size, or location of the crop in a region of interest. In some embodiments, the evaluation for the crop may be informed by locations, parameters, and/or evaluations of previously evaluated crops.

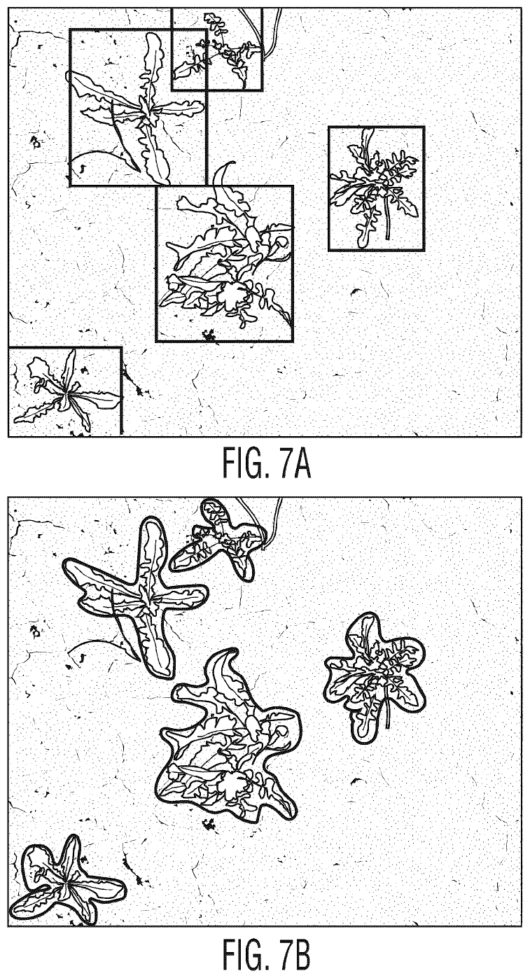

In some embodiments, an evaluation of whether to thin a crop may be performed based on a crop boundary. A boundary may be designated around a crop based on a size of the crop, a type of the crop, a shape of the crop, user input, or combinations thereof. The boundary may represent a space surrounding the crop that is sufficient for the crop to grow to full maturity. The boundary may be any geometric shape or an irregular shape. For example, as illustrated in FIG. 8B, a crop boundary 830 may be rectangular (e.g., a square) or a crop boundary 840 may be elliptical (e.g., a circle). An additional example of rectangular crop boundaries is provided in FIG. 7A. In some embodiments, the crop boundary may be based on a shape of the crop, for example as illustrated in FIG. 7B. Crops located within the boundary of a crop that is not thinned may be selected for thinning. FIG. 8B illustrates an example of a rectangular boundary around a plant being evaluated (left) and a circular boundary around a plant being evaluated (right). Crops, other than the crop being evaluated, that within the boundary are selected for thinning, indicated by X's. selected crops may be targeted and killed (e.g., by irradiating the selected crop with a laser).

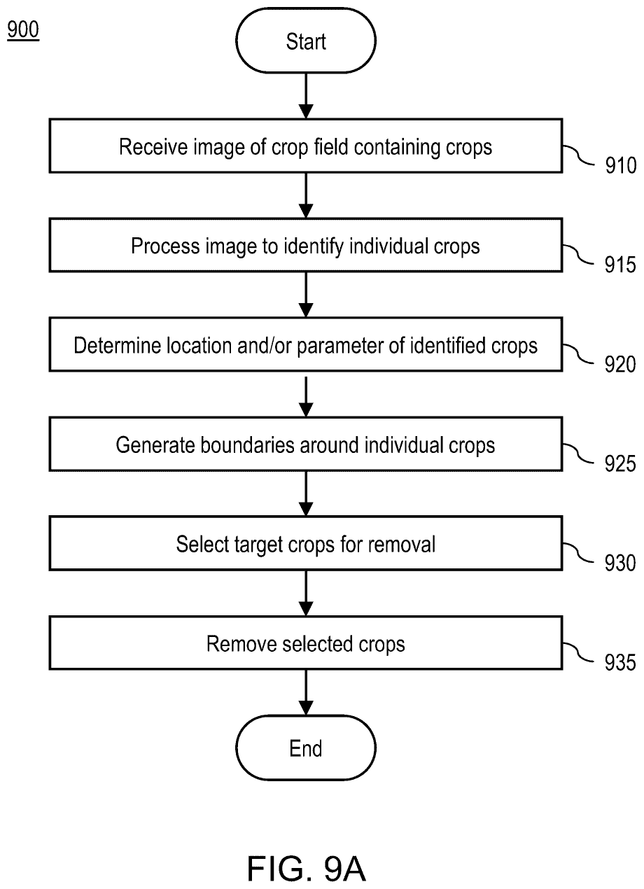

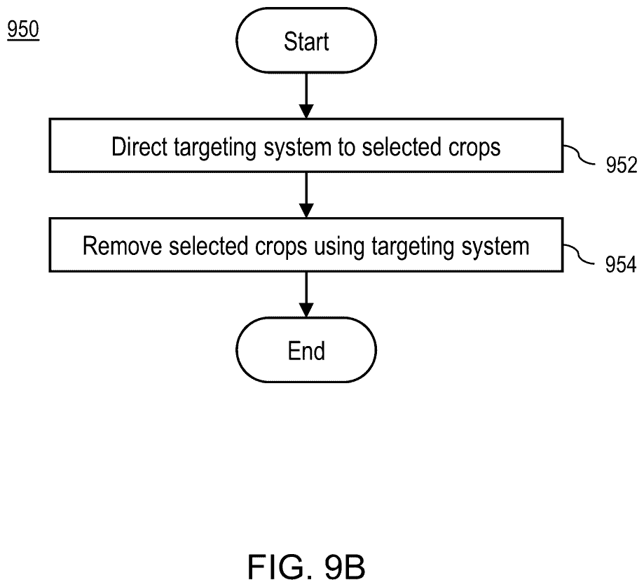

FIG. 9A is a flow diagram illustrating a method 900 of autonomously thinning crops, according to example embodiments of the present disclosure. Method 900 may begin at step 910. At step 910, an image of a crop field containing crops is received (e.g., by an autonomous targeting system). At step 915, the image is processed to identify individual crops. The individual crops identified may be a single type of crop (e.g., onions, peppers, strawberries, carrots, corn, soybeans, barley, oats, wheat, alfalfa, cotton, hay, tobacco, rice, sorghum, tomatoes, potatoes, grapes, rice, lettuce, beans, peas, sugar beets, or brassicas). At step 920, locations and/or parameters are determined for each of the identified crops. Determined parameters may include one or more of plant spacing, plant health, plant size, or growth stage. At step 925, boundaries are generated around each of the identified crops. The boundary may be drawn based on the crop location, the parameters, or both. The boundary may be a geometric shape (e.g., a rectangle, an ellipse, or a polygon). The boundary may closely match the contour of the crop. At step 930, target crops, corresponding to a subset of the identified crops, are selected for removal. The selected target crops may be selected based on their respective locations, parameters, or both. For example, target crops selected for removal may be selected to achieve a desired crop density after removal. Alternatively or in addition, the target crops may be selected to remove crops with poor health. Alternatively or in addition, the target crops may be selected to achieve a narrow distribution of growth stages after removal. At step 935, the selected crops are removed (e.g., using method 950 provided in FIG. 9B).

FIG. 9B is a flow diagram illustrating a method 950 of autonomously removing, according to example embodiments of the present disclosure. Method 950 may begin at step 952. At step 952, a targeting system is directed to crops selected for removal (e.g., selected as shown in method 900 provided in FIG. 9A). At step 954, the selected crops are removed using the targeting system. For example, the targeting system may remove the crops by directing a laser beam toward the selected crop and burning the crop with the laser beam. U.S. Pat. No. 11,602,143, which is incorporated by reference, describes autonomous targeting systems that may be used to perform method 950.

The initial generation of crop boundaries may involve the following steps: Images may be acquired of the target objects. High-resolution images or scans of the crop field are captured using cameras or sensors mounted on the autonomous plant targeting system. Machine learning algorithms, such as convolutional neural networks (CNNs), analyze the images to identify individual crops. These algorithms can be trained on a dataset of labeled images to recognize crop features such as shape, color, and texture. Once a crop is identified, an initial geometric boundary is estimated. This could be a simple shape like a rectangle or ellipse that encompasses the visible area of the crop. The initial boundary may be based on standard geometric shapes that provide a conservative estimate of the space a crop requires to grow, ensuring that the crop is not impeded by neighboring plants. To refine these boundaries to more closely conform to the actual shape of the plant, the following techniques can be employed: Image processing techniques such as edge detection can be used to identify the precise contours of each crop. This helps in adjusting the boundary to match the crop's actual shape. Furthermore, advanced segmentation methods can separate the crop from the background and other plants, allowing for a boundary that follows the crop's silhouette.

Algorithms and machine learning can also further fit the shapes of the bounding boxes more closely to the real-world shape of the object. For example, algorithms can fit complex polygons or spline curves around the detected edges of the crop, creating a boundary that more accurately represents the occupied space. Machine learning models can be further trained with feedback loops to improve boundary accuracy over time, learning from instances where the initial boundary was too large or too small. In some systems, users may provide input to manually adjust the boundaries, which can be incorporated into the machine learning model as additional training data. As the autonomous plant targeting system operates over time, it can collect more data to dynamically adapt the boundaries: The system can use real-time feedback from the thinning process to adjust boundaries for subsequent operations. By tracking plant growth over time, the system can adjust boundaries to accommodate changes in plant size and shape.

In some embodiments, an evaluation of whether to thin a crop may be performed based on a crop size. The size may be evaluated relative to other plants within the region, an expected plant size based on the type and maturity of the crop, or combinations thereof. In some embodiments, the evaluation may be made based on an average size of previously evaluated plants in the region. Average size may be dynamically determined. For example, the average size may be determined by first sampling a configurable number of crops in the region (e.g., about 50 crops) to establish a baseline for the average size. Once the baseline average is determined, sizes of subsequently evaluated crops may be assessed based on a variance from the average size. Crops that fall outside of an acceptable deviation from the average size may be selected for thinning. For example, if a crop is more than about 20% smaller than average or more than about 20% larger than average, the crop may be selected for thinning. Acceptable size deviations may be adjusted based on crop type or other parameter or based on user preference. Sizes of crops determined to be viable (e.g., crops not selected for thinning) may be added to the rolling average and used to evaluate future crops.

In some embodiments, crop evaluation and thinning may be limited to a region of interest (e.g., a band). Crops falling outside of a designated band may be ignored by an autonomous plant targeting system and instead maintained by conventional crop maintenance methods.

Additional methods may be used to determine which crops to target for thinning. In some embodiments, crops may be evaluated one at a time. In some embodiments, an evaluation may be made for multiple crops based on the global arrangement of the crops in a region or sub-region.

### Optical Control Systems

The methods described herein may be implemented by an optical control system, such as a laser optical system, to target an object of interest. For example, an optical system may be used to target an object of interest identified in an image or representation collected by a first sensor, such as a prediction sensor, and locate the same object in an image or representation collected by a second sensor, such as a targeting sensor. In some embodiments, the first sensor is a prediction camera and the second sensor is a targeting camera. Targeting the object may comprise precisely locating the object using the targeting sensor and targeting the object with an implement.

Described herein are optical control systems for directing a beam, for example a light beam, toward a target location on a surface, such as a location of an object of interest. In some embodiments, the implement is a laser. However, other implements are within the scope of the present disclosure, including but not limited to a grabbing implement, a spraying implement, a planting implement, a harvesting implement, a pollinating implement, a marking implement, a blowing implement, or a depositing implement.

In some embodiments, an emitter is configured to direct a beam along an optical path, for example a laser path. In some embodiments, the beam comprises electromagnetic radiation, for example light, radio waves, microwaves, or x-rays. In some embodiments, the light is visible light, infrared light, or ultraviolet light. The beam may be coherent. In one embodiment, the emitter is a laser, such as an infrared laser.

One or more optical elements may be positioned in a path of the beam. The optical elements may comprise a beam combiner, a lens, a reflective element, or any other optical elements that may be configured to direct, focus, filter, or otherwise control light. The elements may be configured in the order of the beam combiner, followed by a first reflective element, followed by a second reflective element, in the direction of the beam path. In another example, one or both of the first reflective element or the second reflective element may be configured before the beam combiner, in order of the direction of the beam path. In another example, the optical elements may be configured in the order of the beam combiner, followed by the first reflective element in order of the direction of the beam path. In another example, one or both of the first reflective element or the second reflective element may be configured before the beam combiner, in the direction of the beam path. Any number of additional reflective elements may be positioned in the beam path.

The beam combiner may also be referred to as a beam combining element. In some embodiments, the beam combiner may be a zinc selenide (ZnSe), zinc sulfide (ZnS), or germanium (Ge) beam combiner. For example, the beam combiner may be configured to transmit infrared light and reflect visible light. In some embodiments, the beam combiner may be a dichroic mirror. In some embodiments, the beam combiner may be configured to pass electromagnetic radiation having a wavelength longer than a cutoff wavelength and reflect electromagnetic radiation having a wavelength shorter than the cutoff wavelength. In some embodiments, the beam combiner may be configured to pass electromagnetic radiation having a wavelength shorter than a cutoff wavelength and reflect electromagnetic radiation having a wavelength longer than the cutoff wavelength. In other embodiments, the beam combiner may be a polarizing beam splitter, a long pass filter, a short pass filter, or a band pass filter.

An optical control system of the present disclosure may further comprise a lens positioned in the optical path. In some embodiments, a lens may be a focusing lens positioned such that the focusing lens focuses the beam, the scattered light, or both. For example, a focusing lens may be positioned in the visible light path to focus the scattered light onto the targeting camera. In some embodiments, a lens may be a defocusing lens positioned such that the defocusing lens defocuses the beam, the scattered light, or both. In some embodiments, the lens may be a collimating lens positioned such that the collimating lens collimates the beam, the scattered light, or both. In some embodiments, two or more lenses may be positioned in the optical path. For example, two lenses may be positioned in the optical path in series to expand or narrow the beam.

The positions and orientations of one or both of the first reflective element and the second reflective element may be controlled by one or more actuators. In some embodiments, an actuator may be a motor, a solenoid, a galvanometer, or a servo. For example, the position of the first reflective element may be controlled by a first actuator, and the position and orientation of the second reflective element may be controlled by a second actuator. In some embodiments, a single reflective element may be controlled by two or more actuators. For example, the first reflective element may be controlled by a first actuator along a first axis and a second actuator along a second axis. Optionally, the mirror may be controlled by a first actuator, a second actuator, and a third actuator, providing multi-axis control of the mirror. In some embodiments, a single actuator may control a reflective element along one or more axes. In some embodiments, a single reflective element may be controlled by a single actuator.

An actuator may change a position of a reflective element by rotating the reflective element, thereby changing an angle of incidence of a beam encountering the reflective element. Changing the angle of incidence may cause a translation of the position at which the beam encounters the surface. In some embodiments, the angle of incidence may be adjusted such that the position at which the beam encounters the surface is maintained while the optical system moves with respect to the surface. In some embodiments, the first actuator rotates the first reflective element about a first rotational axis, thereby translating the position at which the beam encounters the surface along a first translational axis, and the second actuator rotates the second reflective element about a second rotational axis, thereby translating the position at which the beam encounters the surface along a second translational axis. In some embodiments, a first actuator and a second actuator rotate a first reflective element about a first rotational axis and a second rotational axis, thereby translating the position at which the beam encounters the surface of the first reflective element along a first translational axis and a second translational axis. For example, a single reflective element may be controlled by a first actuator and a second actuator, providing translation of the position at which the beam encounters the surface along a first translation axis and a second translation axis with a single reflective element controlled by two actuators. In another example, a single reflective element may be controlled by one, two, or three actuators.

The first translational axis and the second translational axis may be orthogonal. A coverage area on the surface may be defined by a maximum translation along the first translational axis and a maximum translation along the second translation axis. One or both of the first actuator and the second actuator may be servo-controlled, piezoelectric actuated, piezo inertial actuated, stepper motor-controlled, galvanometer-driven, linear actuator-controlled, or any combination thereof. One or both of the first reflective element and the second reflective element may be a mirror; for example, a dichroic mirror, or a dielectric mirror; a prism; a beam splitter; or any combination thereof. In some embodiments, one or both of the first reflective element and the second reflective element may be any element capable of deflecting the beam.

A targeting camera may be positioned to capture light, for example visible light, traveling along a visible light path in a direction opposite the beam path, for example laser path. The light may be scattered by a surface, such as the surface with an object of interest, or an object, such as an object of interest, and travel toward the targeting camera along visible light path. In some embodiments, the targeting camera is positioned such that it captures light reflected off of the beam combiner. In other embodiments, the targeting camera is positioned such that it captures light transmitted through the beam combiner. With the capture of such light, the targeting camera may be configured to image a target field of view on a surface. The targeting camera may be coupled to the beam combiner, or the targeting camera may be coupled to a support structure supporting the beam combiner. In one embodiment, the targeting camera does not move with respect to the beam combiner, such that the targeting camera maintains a fixed position relative to the beam combiner.

An optical control system of the present disclosure may further comprise an exit window positioned in the beam path. In some embodiments, the exit window may be the last optical element encountered by the beam prior to exiting the optical control system. The exit window may comprise a material that is substantially transparent to visible light, infrared light, ultraviolet light, or any combination thereof. For example, the exit window may comprise glass, quartz, fused silica, zinc selenide, zinc sulfide, a transparent polymer, or a combination thereof. In some embodiments, the exit window may comprise a scratch-resistant coating, such as a diamond coating. The exit window may prevent dust, debris, water, or any combination thereof from reaching the other optical elements of the optical control system. In some embodiments, the exit window may be part of a protective casing surrounding the optical control system.

After exiting the optical control system, the beam may be directed along beam path toward a surface. In some embodiments, the surface contains an object of interest, for example a plant. Rotational motions of reflective elements may produce a laser sweep along a first translational axis and a laser sweep along a second translational axis. The rotational motions of reflective elements may control the location at which the beam encounters the surface. For example, the rotation motions of reflective elements may move the location at which the beam encounters the surface to a position of an object of interest on the surface. In some embodiments, the beam is configured to damage the object of interest. For example, the beam may comprise electromagnetic radiation, and the beam may irradiate the object. In another example, the beam may comprise infrared light, and the beam may burn the object. In some embodiments, one or both of the reflective elements may be rotated such that the beam scans an area surrounding and including the object.

A prediction camera or prediction sensor may coordinate with an optical control system, such as optical control system, to identify and locate objects to target. The prediction camera may have a field of view that encompasses a coverage area of the optical control system covered by amiable laser sweeps. The prediction camera may be configured to capture an image or representation of a region that includes the coverage area to identify and select an object to target. The selected object may be assigned to the optical control system. In some embodiments, the prediction camera field of view and the coverage area of the optical control system may be temporally separated such that prediction camera field of view encompasses the target at a first time and the optical control system coverage area encompasses the target at a second time. Optionally, the prediction camera, the optical control system, or both may move with respect to the target between the first time and the second time.

In some embodiments, two or more optical control systems may be combined to increase a coverage area on a surface. The two or more optical control systems may be configured such that the laser sweep along a translational axis of each optical control system overlaps with the laser sweep along the translational axis of the neighboring optical control system. The combined laser sweep defines a coverage area that may be reached by at least one beam of two or more beams from the two or more optical control systems. One or more prediction cameras may be positioned such that a prediction camera field of view covered by the one or more prediction cameras fully encompasses the coverage area. In some embodiments, a detection system may comprise two or more prediction cameras, each having a field of view. The fields of view of the prediction cameras may be combined to form a prediction field of view that fully encompass the coverage area. In some embodiments, the prediction field of view does not fully encompass the coverage area at a single time point but may encompass the coverage area over two or more time points (e.g., image frames). Optionally, the prediction camera or cameras may move relative to the coverage area over the course of the two or more time points, enabling temporal coverage of the coverage area. The prediction camera or prediction sensor may be configured to capture an image or representation of a region that includes coverage area to identify and select an object to target. The selected object may be assigned to one of the two or more optical control systems based on the location of the object and the area covered by laser sweeps of the individual optical control systems.

The two or more optical control systems may be configured on a vehicle, such as vehicle 100 illustrated in FIG. 1-FIG. 3. For example, the vehicle may be a driverless vehicle. The driverless vehicle may be a robot. In some embodiments, the vehicle may be controlled by a human. For example, the vehicle may be driven by a human driver. In some embodiments, the vehicle may be coupled to a second vehicle being driven by a human driver, for example towed behind or pushed by the second vehicle. The vehicle may be controlled by a human remotely, for example by remote control. In some embodiments, the vehicle may be controlled remotely via longwave signals, optical signals, satellite, or any other remote communication method. The two or more optical control systems may be configured on the vehicle such that the coverage area overlaps with a surface underneath, behind, in front of, or surrounding the vehicle.

The vehicle may be configured to navigate a surface containing multiple objects, including one or more objects of interest, for example a crop field containing multiple plants, including one or more plants of interest. The vehicle may comprise one or more of wheels, a power source, a motor, a prediction camera, or any combination thereof. In some embodiments, the vehicle has sufficient clearance above the surface to drive over a plant, for example a crop, without damaging the plant. In some embodiments, a space between an inside edge of a left wheel and an inside edge of a right wheel is wide enough to pass over a row of plants without damaging the plants. In some embodiments, a distance between an outside edge of a left wheel and an outside edge of a right wheel is narrow enough to allow the vehicle to pass between two rows of plants, for example two rows of crops, without damaging the plants. In one embodiment, the vehicle comprising the wheels, the two or more optical control systems, and the prediction camera may navigate rows of crops and emit a beam of the two or more beams toward a target, for example a plant, thereby burning or irradiating the plant.

### Computer Systems and Methods

The methods described herein may be implemented using a computer system. In some embodiments, the systems described herein include a computer system. In some embodiments, a computer system may implement the methods autonomously without human input. In some embodiments, a computer system may implement the methods based on instructions provided by a human user through a detection terminal.

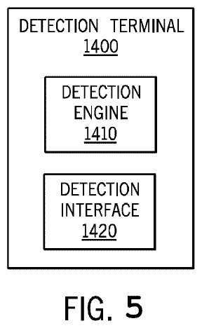

FIG. 5 illustrates components in a block diagram of a non-limiting exemplary embodiment of a detection terminal 1400 according to various aspects of the present disclosure. In some embodiments, the detection terminal 1400 is a device that displays a user interface in order to provide access to the detection system. As shown, the detection terminal 1400 includes a detection interface 1420. The detection interface 1420 allows the detection terminal 1400 to communicate with a detection system, such a detection system of FIG. 3 or FIG. 4. In some embodiments, the detection interface 1420 may include an antenna configured to communicate with the detection system, for example by remote control. In some embodiments, the detection terminal 1400 may also include a local communication interface, such as an Ethernet interface, a Wi-Fi interface, or other interface that allows other devices associated with detection system to connect to the detection system via the detection terminal 1400. For example, a detection terminal may be a handheld device, such as a mobile phone, running a graphical interface that enables a user to operate or monitor the detection system remotely over Bluetooth, Wi-Fi, or mobile network.

The detection interface may support various communication protocols to ensure compatibility and interoperability with different devices and systems. These protocols could include cellular networks (e.g., LTE, 5G) for remote communication, enabling the user to control and receive updates from the system from virtually anywhere, and LoRaWAN for long-range, low-power communication, particularly useful in rural or expansive agricultural settings. Regarding the hardware associated with the detection interface 1420, the detection interface may include hardware components such as: transceivers capable of both transmitting and receiving signals, signal amplifiers to boost communication range and quality, microcontrollers or processors to manage communication protocols and data handling, power management circuits to ensure efficient energy use, especially when the system is battery-powered. In other example embodiments, the detection interface enables several functional capabilities, such as: real-time data transmission, allowing the user to receive live updates on the system's status and the progress of the crop thinning process; remote control commands, enabling the user to start, stop, or adjust the operation of the autonomous plant targeting system from the detection terminal; software updates and configuration changes that can be sent to the autonomous system to improve performance or modify operational parameters; and diagnostic data retrieval for maintenance and troubleshooting purposes.

The detection terminal 1400 further includes detection engine 1410. The detection engine may receive information regarding the status of a detection system, for example a detection system of FIG. 3 or FIG. 4. The detection engine may receive information regarding the number of objects identified, the identity of objects identified, the location of objects identified, the trajectories and predicted locations of objects identified, the number of objects targeted, the identity of objects targeted, the location of objects targeted, the location of the detection system, the elapsed time of a task performed by the detection system, an area covered by the detection system, a battery charge of the detection system, or combinations thereof.

In other example embodiments, the detection engine may receive additional types of information, including: environmental data such as: temperature and humidity levels; soil moisture content; weather conditions impacting the operation, like wind speed and precipitation; and light intensity and spectral data for assessing photosynthetic activity. The detection engine may also receive metrics related to the performance and efficiency of the autonomous system, such as: energy consumption and battery life estimates; area coverage rate, indicating how quickly the system is progressing through the field; number of plants thinned per unit of time; operational logs detailing system activity and any errors or malfunctions. Furthermore, the detection engine may receive Data points that provide insights into the health and status of the crops, such as spectral analysis results that may indicate plant stress or disease; growth metrics, including plant height and leaf area index (LAI); imagery data that could reveal signs of pest infestation or nutrient deficiencies. Even further, the detection engine may receive information related to the autonomous system's navigation and positioning within the field, such as GPS coordinates and path tracking data; obstacle detection and avoidance logs; and alignment with crop rows and accuracy of movement relative to the planned path.

Actual embodiments of the illustrated devices will have more components included therein which are known to one of ordinary skill in the art. For example, each of the illustrated devices will have a power source, one or more processors, computer-readable media for storing computer-executable instructions, and so on. These additional components are not illustrated herein for the sake of clarity.

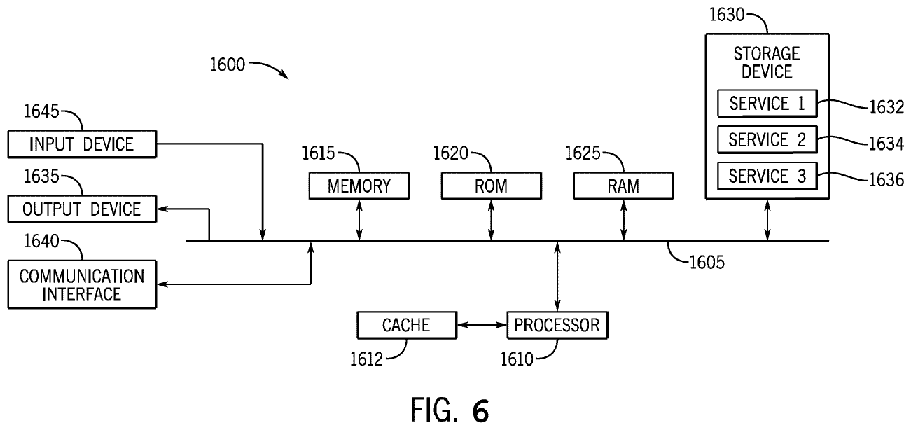

In some examples, the procedures described herein may be performed by a computing device or apparatus, such as a computing device having the computing device architecture 1600 shown in FIG. 6. In one example, the procedures described herein can be performed by a computing device with the computing device architecture 1600. The computing device can include any suitable device, such as a mobile device (e.g., a mobile phone), a desktop computing device, a tablet computing device, a wearable device, a server (e.g., in a software as a service (Saas) system or other server-based system), and/or any other computing device with the resource capabilities to perform the processes described herein, including procedure 500 or 600. In some cases, the computing device or apparatus may include various components, such as one or more input devices, one or more output devices, one or more processors, one or more microprocessors, one or more microcomputers, and/or other component that is configured to carry out the steps of processes described herein. In some examples, the computing device may include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Procedures 500 and 600 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising instructions executable by one or more processors. The computer-readable or machine-readable storage medium may be non-transitory.

FIG. 6 illustrates an example computing device architecture 1600 of an example computing device which can implement the various techniques described herein. For example, the computing device architecture 1600 can implement the procedures described herein, control the detection system shown in FIG. 3 or FIG. 4, or control the vehicles shown in FIG. 1 and FIG. 2. The components of computing device architecture 1600 are shown in electrical communication with each other using connection 1605, such as a bus. The example computing device architecture 1600 includes a processing unit (which may include a CPU and/or GPU) 1610 and computing device connection 1605 that couples various computing device components including computing device memory 1615, such as read only memory (ROM) 1620 and random access memory (RAM) 1625, to processor 1610. In some embodiments, a computing device may comprise a hardware accelerator.

Computing device architecture 1600 can include a cache of high-speed memory connected directly with, in close proximity to, or integrated as part of processor 1610. Computing device architecture 1600 can copy data from memory 1615 and/or the storage device 1630 to cache 1612 for quick access by processor 1610. In this way, the cache can provide a performance boost that avoids processor 1610 delays while waiting for data. These and other modules can control or be configured to control processor 1610 to perform various actions. Other computing device memory 1615 may be available for use as well. Memory 1615 can include multiple different types of memory with different performance characteristics. Processor 1610 can include any general purpose processor and a hardware or software service, such as service 1 1632, service 2 1634, and service 3 1636 stored in storage device 1630, configured to control processor 1610 as well as a special-purpose processor where software instructions are incorporated into the processor design. Processor 1610 may be a self-contained system, containing multiple cores or processors, a bus, memory controller, cache, etc. A multi-core processor may be symmetric or asymmetric.

To enable user interaction with the computing device architecture, input device 1645 can represent any number of input mechanisms, such as a microphone for speech, a touch-sensitive screen for gesture or graphical input, keyboard, mouse, motion input, speech and so forth. Output device 1635 can also be one or more of a number of output mechanisms known to those of skill in the art, such as a display, projector, television, speaker device, etc. In some instances, multimodal computing devices can enable a user to provide multiple types of input to communicate with computing device architecture 1600. Communication interface 1640 can generally govern and manage the user input and computing device output. There is no restriction on operating on any particular hardware arrangement and therefore the basic features here may easily be substituted for improved hardware or firmware arrangements as they are developed.

Storage device 1630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1625, read only memory (ROM) 1620, and hybrids thereof. Storage device 1630 can include services 1632, 1634, 1636 for controlling processor 1610. Other hardware or software modules are contemplated. Storage device 1630 can be connected to the computing device connection 1605. In one aspect, a hardware module that performs a particular function can include the software component stored in a computer-readable medium in connection with the necessary hardware components, such as processor 1610, connection 1605, output device 1635, and so forth, to carry out the function.

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods, and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, two or more microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

While illustrative embodiments have been illustrated and described, it will be appreciated that various changes can be made therein without departing from the spirit and scope of the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

While preferred embodiments of the present invention have been shown and described herein, it will be apparent to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed. The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A method for autonomous crop thinning, comprising:
receiving, by a processor, one or more images of a crop field containing crops;
processing, by the processor, the images using a machine learning model to identify one or more individual crops;
determining, by the processor, a location and a parameter of each of the one or more identified crops;
generating a crop boundary around each identified crop based on the location, the parameter, or both of each of the one or more identified crops; and
selecting target crops for removal based on their respective parameters, locations relative to the crop boundaries, or both.

2. The method of claim 1, wherein the method further comprises directing an autonomous vehicle equipped with a targeting system capable of removing the selected target crops.

3. The method of claim 2, wherein the targeting system comprises a laser capable of irradiating the selected target crops.

4. The method of claim 2, further comprising removing the selected target crops with the targeting system.

5. The method of claim 4, wherein removing the selected target crops comprises irradiating the target crops with a laser.

6. The method of claim 2, wherein the method further comprises updating the crop boundaries based on real-time feedback from the targeting system.

7. The method of claim 1, wherein selection of target crops for removal is based at least on a predetermined crop spacing within the crop field.

8. The method of claim 1, wherein the machine learning model is a convolutional neural network trained to recognize crop features.

9. The method of claim 1, wherein the parameter of each identified crop includes at least one of health, size, or growth stage.

10. The method of claim 1, wherein the crop boundary is designated as a geometric shape selected from the group consisting of a rectangle, an ellipse, and a polygon that closely matches a contour of the crop.

11. The method of claim 1, wherein determining the location of the individual crop may comprise generating a virtual representation of a region around the individual crop.

12. An autonomous plant targeting system comprising:
a processor; and
a memory comprising instructions stored thereon, which, when executed by the processor causes the system to perform operations comprising:
receiving, by the processor, one or more images of a crop field containing crops;
processing, by the processor, the images using a machine learning model to identify one or more individual crops;
determining, by the processor, a location and a parameter of each of the one or more identified crops;
generating, by the processor, a crop boundary around each identified crop based on the location, the parameter, or both of each of the one or more identified crops; and
selecting, by the processor, target crops for removal based on their respective parameters, locations relative to the crop boundaries, or both.

13. The system of claim 12, wherein the machine learning model is a convolutional neural network trained to recognize crop features.

14. The system of claim 12, wherein the targeting system comprises a laser capable of irradiating the selected target crops.

15. The system of claim 12, wherein the system further comprises directing, by the processor, an autonomous vehicle equipped with a targeting system to remove the selected target crops.

16. The system of claim 15, wherein the autonomous vehicle includes a detection system that dynamically updates a virtual representation of the crop field as the vehicle moves through the field.

17. The system of claim 15, wherein the autonomous vehicle collects environmental data from the crop field and adjusts the removal operations based on the collected data.

18. The system of claim 12, wherein the selecting of target crops for removal is further based on a predetermined crop spacing within the crop field.

19. The system of claim 12, wherein the parameter of each identified crop includes at least one of health, size, or growth stage.

20. The system of claim 12, wherein the crop boundary is designated as a geometric shape selected from the group consisting of a rectangle, an ellipse, and a polygon that closely matches a contour of the crop.

21. The system of claim 12, wherein determining the location of the individual crop may comprise generating a virtual representation of a region around the individual crop.

22. A non-transitory computer readable medium containing computer executable instructions that, when executed by a computer hardware arrangement, cause the computer hardware arrangement to perform procedures comprising:
receiving one or more images of a crop field containing crops;
processing the images using a machine learning model to identify one or more individual crops;
determining a location and a parameter of each of the one or more identified crops;
generating a crop boundary around each identified crop based on the location, the parameter, or both of each of the one or more identified crops; and
selecting target crops for removal based on their respective parameters, locations relative to the crop boundaries, or both.
